(19) United States
(12) Patent Application Publication
(10) Pub. No.: US 2024/0430415 A1
(43) Pub. Date: Dec. 26, 2024

(54) Adaptive Filter Computation Precision in Video Coding

(71) Applicant: Google LLC, Mountain View, CA (US)

(72) Inventor: Yunqing Wang, Palo Alto, CA (US)

(21) Appl. No.: 18/213,713

(22) Filed: Jun. 23, 2023

(51) Int. Cl. H04N 19/117; H04N 19/176; H04N 19/80

(52) U.S. Cl. CPC H04N 19/117; H04N 19/176; H04N 19/80

(57) ABSTRACT

Filtering for a block of pixels that uses variable rounding bits to change the resolution of a filter result is described. The rounding bits are derived adaptively for the block for high precision in the filtering calculations. While useful to change the bit depth in single-stage filtering, the techniques are particularly useful for multi-stage filtering. A first filtering operation may be performed on the block having an input bit depth. The output is an intermediate filter result with a precision greater than the input bit depth. A rounding bit value for modifying the precision of the intermediate filter result is adaptively determined. The precision is modified using the rounding bit value. Thereafter, a second filtering operation may be performed on the intermediate filter result. An output of the second filtering operation is a filtered block of pixels, with which a coding operation may be performed.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other encoding techniques.

Video coding can exploit the spatial and temporal correlations in video signals to achieve a good compression efficiency. In brief, pixels of the current frame and/or a reference frame can be used to generate a prediction block that corresponds to a current block to be encoded. Differences between the prediction block and the current block can be encoded, instead of the values of the current block themselves, to reduce the amount of data encoded.

### SUMMARY

This disclosure relates generally to encoding and decoding video data and more particularly relates to adaptive filter computation precision in video coding.

According to an aspect of the teachings herein, a method includes performing a first filtering operation on a block of pixels, wherein values of the pixels have an input bit depth, and an output of the first filtering operation is an intermediate filter result with a precision that is greater than the input bit depth, adaptively determining a rounding bit value for modifying the precision of the intermediate filter result, modifying the precision of the intermediate filter result using the rounding bit value, performing a second filtering operation on the intermediate filter result after modifying the precision, wherein an output of the second filtering operation comprises a filtered block of pixels, and performing a coding operation using the filtered block of pixels.

In some implementations, the filtered block of pixels is a prediction block and performing the coding operation includes decoding a current block of a frame using the prediction block.

In some implementations, adaptively determining the rounding bit value includes determining a maximum number of bits required to represent a range of values of the intermediate filter result and determining the rounding bit value as a difference between the maximum number of bits and a defined output resolution of the first filtering operation. In a variation of these implementations, determining the maximum number of bits can include determining a maximum value of the input block of pixels, determining a minimum value of the input block of pixels, estimating a maximum value of the intermediate filter result using the maximum value of the input block of pixels, the minimum value of the input block of pixels, and filter coefficients of the first filtering operation, estimating a minimum value of the intermediate filter result using the maximum value of the input block of pixels, the minimum value of the input block of pixels, and filter coefficients of the first filtering operation, and determining the maximum number of bits as a difference between the maximum value of the intermediate filter result and the minimum value of the intermediate filter result.

In another variation of these implementations, determining the maximum number of bits can include determining a maximum value of the intermediate filter result, determining a minimum value of the intermediate filter result, and determining the maximum number of bits as a difference between the maximum value and the minimum value.

In some implementations, before performing the coding operation, the method includes adaptively determining a second rounding bit value for modifying a precision of the filtered block of pixels and modifying the precision of the filtered block of pixels using the second rounding bit value.

In some implementations, the rounding bit value is a negative number and modifying the precision of the intermediate filter result includes left shifting values of the intermediate filter result by a number of bits indicated by the negative number.

In some implementations, the method includes clamping the filtered block of pixels to an output bit depth different from the input bit depth before performing the coding operation.

According to another aspect of the teachings herein, an apparatus includes a processor configured to perform a first filtering operation on a block of pixels, wherein values of the pixels have an input bit depth, and an output of the first filtering operation is an intermediate filter result with a precision that is greater than the input bit depth, adaptively determine a rounding bit value for modifying the precision of the intermediate filter result, modify the precision of the intermediate filter result using the rounding bit value, perform a second filtering operation on the intermediate filter result after modifying the precision, wherein an output of the second filtering operation comprises a filtered block of pixels, and perform a coding operation using the filtered block of pixels.

In some implementations, to perform the first filtering operation includes to apply a horizontal filter to the input block of pixels and to perform the second filtering operation includes to apply a vertical filter to the intermediate filter result after modifying the precision. In other implementations, to perform the first filtering operation includes to apply a vertical filter to the input block of pixels and to perform the second filtering operation includes to apply a horizontal filter to the intermediate filter result after modifying the precision.

In some implementations, the processor is configured to adaptively determine a second rounding bit value for modifying a precision of the filtered block of pixels, modify the precision of the filtered block of pixels using the second rounding bit value, and perform the coding operation after modifying the precision of the filtered block of pixels. In a variation of these implementations, the processor is configured to clamp a precision of the filtered block of pixels to a value different from a modified precision of the filtered block of pixels. A modified precision of the filter block of pixels may be greater than the input depth. In a variation of these implementations, to adaptively determine the rounding bit value includes to determine the rounding bit value using values of the input block of pixels, filter coefficients of the first filtering operation, and a defined output resolution of the first filtering operation, and to adaptively determine the second rounding bit value includes to determine the second rounding bit value using values of the intermediate filter result after modifying the precision of the intermediate filter result, filter coefficients of the second filtering operation, and a defined output resolution of the second filtering operation.

In some implementations, to adaptively determine the rounding bit value includes to determine the rounding bit value using values of the input block of pixels, filter coefficients of the first filtering operation, and a defined output resolution of the first filtering operation. In a variation of these implementations, to determine the rounding bit value using the values of the input block of pixels, the filter coefficients of the first filtering operation, and the defined output resolution of the first filtering operation includes to determine a minimum (pₘᵢₙ) value and a maximum (pₘₐₓ) value of the input block of pixels, to determine a sum of positive filter coefficients (sum_f_pos) and a sum of negative filter coefficients (sum_f_neg) of the filter coefficients, to estimate a maximum value of the intermediate filter result (max) according to:

max=sum_f_pos*pₘₐₓ+sum_f_neg*pₘᵢₙ;

to estimate a minimum value of the intermediate filter result (min) according to:

min=sum_f_pos*pₘᵢₙ+sum_f_neg*pₘₐₓ;

determine a result range [0, max−min] of the intermediate filter result that is represented by t bits, and determine the rounding bit value as (t−y), wherein y bits is the defined output resolution of the first filtering operation.

In another variation of these implementations, to adaptively determine the rounding bit value includes to determine the rounding bit value using values of the input block of pixels, filter coefficients of the first filtering operation, and a defined output resolution of the first filtering operation includes to determine a maximum value of the intermediate filter result (max), determine a minimum value of the intermediate filter result (min), determine a result range [0, max−min] of the intermediate filter result that is represented by t bits, and determine the rounding bit value as (t−y), wherein y bits is the defined output resolution of the first filtering operation.

In either of these variations, to modify the precision of the intermediate filter result can include to right shift values of the intermediate filter result by (t−y) bits when t>y, and otherwise, to left shift values of the intermediate filter result by (y−t) bits.

According to yet another aspect of the teachings herein, a computer-readable storage medium stores instructions for performing another of the methods described above.

These and other aspects, implementations, and variations of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views unless otherwise noted.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of an encoder according to implementations of this disclosure.

FIG. 5 is a block diagram of a decoder according to implementations of this disclosure.

FIG. 6 is a diagram of motion vectors representing full and sub-pixel motion according to implementations of this disclosure.

FIG. 7 is a diagram of a sub-pixel prediction block according to implementations of this disclosure.

FIG. 8 is a diagram of full and sub-pixel positions according to implementations of this disclosure.

FIG. 9 is a flowchart diagram of a process for coding a current block of a video frame using adaptive filter computation precision according to an implementation of this disclosure.

FIG. 10 is a diagram of a stage of the filter algorithm described with regards to FIG. 9.

### DETAILED DESCRIPTION

A video stream can be compressed by a variety of techniques to reduce the bandwidth required to transmit or store the video stream. A video stream can be encoded into a bitstream (i.e., a compressed bitstream), which involves compression. The compressed bitstream can then be transmitted to a decoder that can decode or decompress the compressed bitstream to prepare it for viewing or further processing. Compression of the video stream often exploits spatial and temporal correlation of video signals through spatial and/or motion-compensated prediction.

Spatial prediction may also be referred to as intra prediction. Intra prediction uses previously encoded and decoded pixels from at least one block adjacent to a current block to be encoded to generate a block (also called a prediction block) that resembles the current block. By encoding the intra prediction mode and the difference between the two blocks (i.e., the current block and the prediction block), a decoder receiving the encoded signal can re-create the current block. Motion-compensated prediction may also be referred to as inter prediction. Inter prediction uses one or more motion vectors to generate a prediction block that resembles a current block to be encoded using previously encoded and decoded pixels. By encoding the motion vector(s) and the difference between the two blocks (i.e., the current block and the prediction block), a decoder receiving the encoded signal can re-create the current block. The difference between the two blocks, whether generated using inter prediction or intra prediction, is referred to herein as the residual or the residual block.

In many situations, the prediction block may be improved by performing a filtering process. That is, unfiltered pixels (e.g., a pixel block of the current frame or a reference frame) may be input into a filter whose output comprises filtered pixels (e.g., a prediction block). The filter formula may be represented by equation (1) below:

$${p}_{i}^{′} = {\sum }_{k = 0}^{n} ( {f}_{k} * {p}_{k} )$$

In the above equation, p′ is the filtered pixel value, p is the unfiltered pixel value, f is the filter coefficient, and k is the filter tap for an n-tap filter.

A multi-pass filtering process may be used by an encoder and decoder to produce a prediction block. Horizontal filtering may be followed by vertical filtering, or vice versa. For compound prediction modes, multiple prediction blocks may be computed and combined (e.g., averaged) to construct a final prediction block. In each of these processes, an intermediate filter result is generated. The intermediate filter result may have a higher precision than the pixel bit depth.

Using a higher precision for an intermediate filter result can improve the filter performance. Further improvement to the filter performance may result from allowing the filter computation precision to adapt to the input signal. Details of this improvement are described hereinbelow after a description of the environment in which the teachings herein may be implemented.

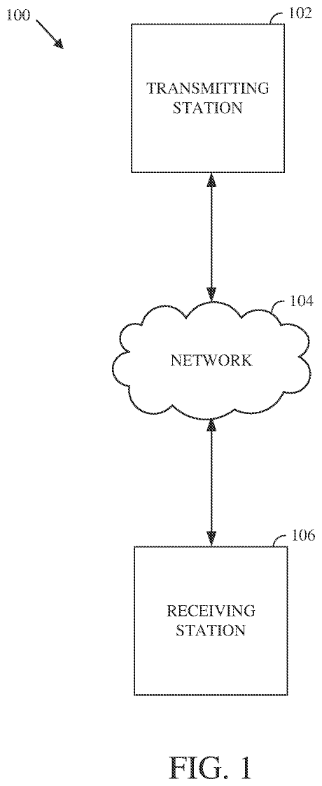

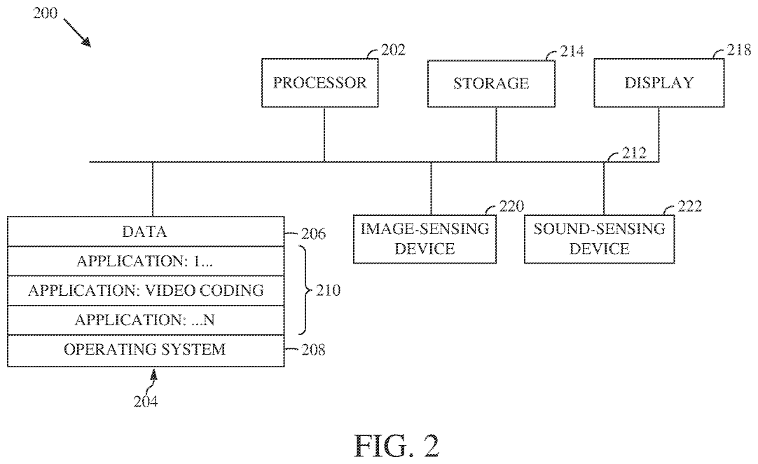

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having a non-transitory storage medium or memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device or non-transitory storage medium can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into a single unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

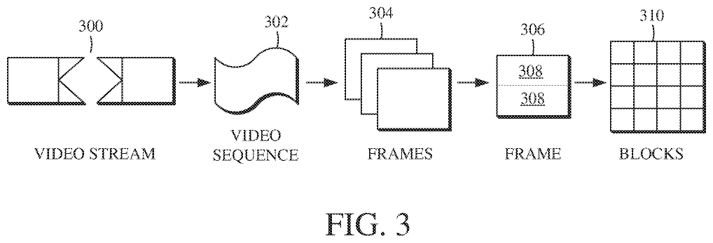

FIG. 3 is a diagram of an example of a video stream 300 to be encoded and subsequently decoded. The video stream 300 includes a video sequence 302. At the next level, the video sequence 302 includes multiple adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

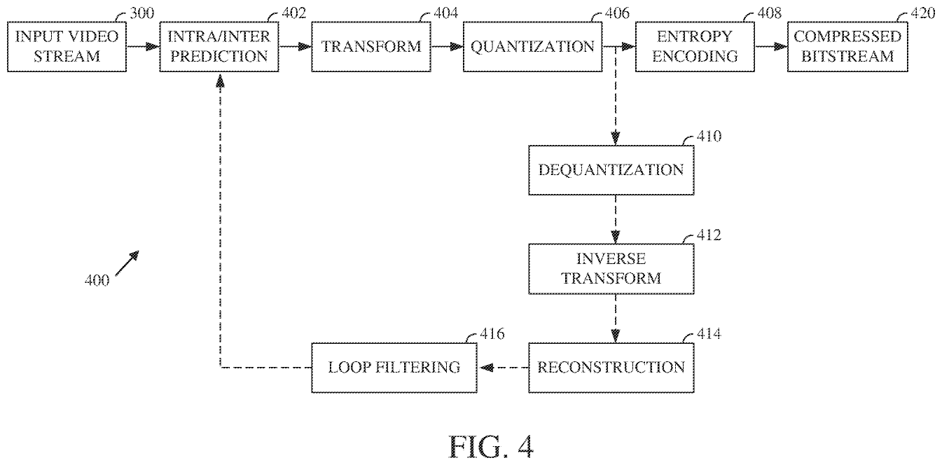

FIG. 4 is a block diagram of an encoder 400 according to implementations of this disclosure. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. The encoder 400 may be a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs similar functions to those functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

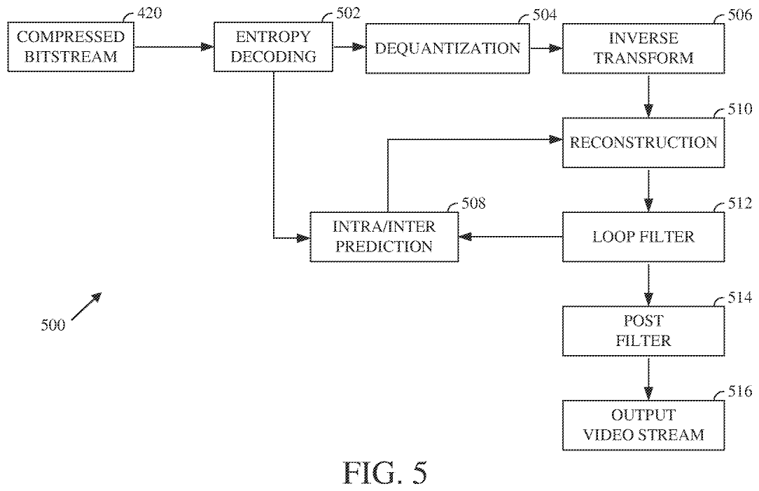

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described herein. The decoder 500 can also be implemented in hardware included in, for example, the transmitting station 102 or the receiving station 106. The decoder 500 may be a hardware decoder.

The decoder 500, like the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post filtering stage 514 can be a deblocking filter that is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post filtering stage 514.

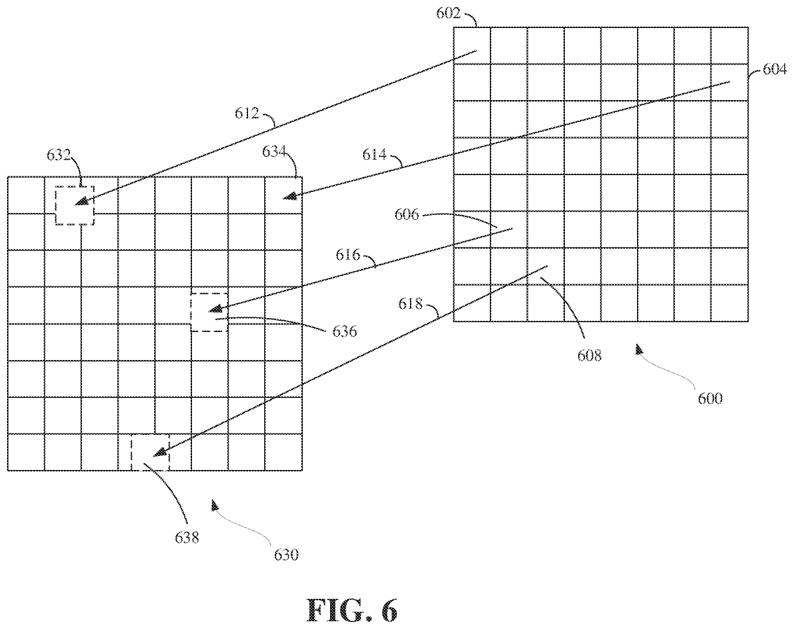

As discussed briefly above, during the prediction processes at an encoder and a decoder, pixels may be filtered using an adaptive computation precision to produce filtered pixel values for a prediction block. An example of using adaptive filter computation precision is described below with reference to interpolation filters for inter prediction using FIGS. 6-8. The use of adaptive filter computation precision described herein is not limited to interpolation filters. Instead, the techniques described herein may be used for filtering inter-predicted blocks, intra-predicted blocks whether determined using interpolation filters or not, or both intra-predicted and inter-predicted blocks.

FIG. 6 is a diagram of motion vectors representing full and sub-pixel motion. In FIG. 6, several blocks 602, 604, 606, 608 of a current frame 600 are inter predicted using pixels from a reference frame 630. In this example, the reference frame 630 may be a temporally adjacent frame in a video sequence including the current frame 600, such as the video stream 300. The reference frame 630 is a reconstructed frame (i.e., one that has been encoded and decoded such as by the reconstruction path of FIG. 4) that has been stored in a so-called last reference frame buffer and is available for coding blocks of the current frame 600. Other (e.g., reconstructed) frames, or portions of such frames may also be available for inter prediction. Other available reference frames may include a golden frame, which is another frame of the video sequence that may be selected (e.g., periodically) according to any number of techniques, and a constructed reference frame, which is a frame that is constructed from one or more other frames of the video sequence but is not shown as part of the decoded output, such as the output video stream 516 of FIG. 5.

A prediction block 632 for encoding the block 602 corresponds to a motion vector 612. A prediction block 634 for encoding the block 604 corresponds to a motion vector 614. A prediction block 636 for encoding the block 606 corresponds to a motion vector 616. Finally, a prediction block 638 for encoding the block 608 corresponds to a motion vector 618. Each of the blocks 602, 604, 606, 608 is inter predicted using a single motion vector and hence a single reference frame in this example, but the teachings herein also apply to inter prediction using more than one motion vector (such as bi-prediction and/or compound prediction using at least two different reference frames), where pixels from each prediction are combined to form a prediction block.

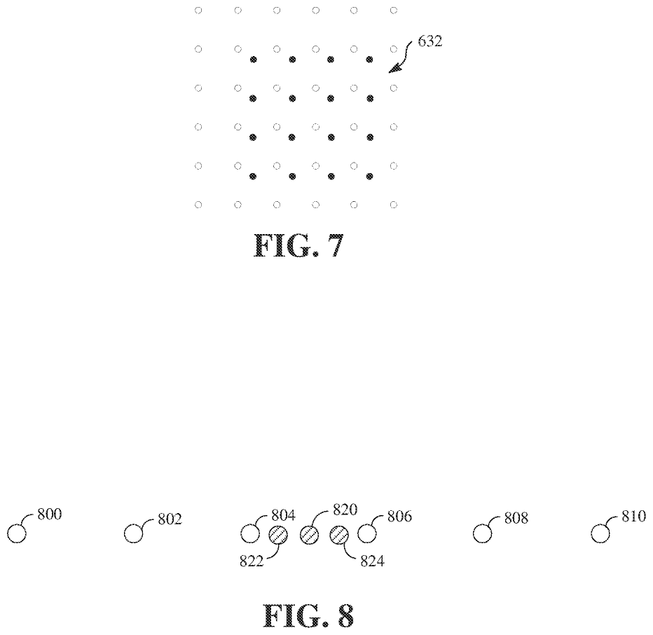

FIG. 7 is a diagram of a sub-pixel prediction block. FIG. 7 includes the block 632 and neighboring pixels of the block 632 of the reference frame 630 of FIG. 6. Integer pixels within the reference frame 630 are shown as unfilled circles. The integer pixels, in this example, represent reconstructed pixel values of the reference frame 630. The integer pixels are arranged in an array along X and Y axes. Pixels forming the prediction block 632 are shown as filled circles. The prediction block 632 results from sub-pixel motion along two axes in this example, but the teachings herein can be applied where there is sub-pixel motion along only one axis.

Generating the prediction block 632 can require two interpolation operations. In some cases, generating a prediction block can require only one interpolation operation along one of the X or Y axes. A first interpolation operation to generate intermediate pixels followed by a second interpolation operation to generate the pixels of the prediction block from the intermediate pixels. The first and the second interpolation operations can be along the horizontal direction (i.e., along the X axis) and the vertical direction (i.e., along the Y axis), respectively. Alternatively, the first and the second interpolation operations can be along the vertical direction (i.e., along the Y axis) and the horizontal direction (i.e., along the X axis), respectively. Stated differently, a first filtering operation can use a horizontal filter and a second filtering operation can use a vertical filter, or vice versa. The first and second interpolation operations can use a same interpolation filter type. Alternatively, the first and second interpolation operations can use different interpolation filter types.

To produce pixel values for the sub-pixels of the prediction block 632, an interpolation process may be used. In one example, the interpolation process is performed using interpolation filters such as finite impulse response (FIR) filters. An interpolation filter may comprise a 6-tap filter, an 8-tap filter, or other size filters. The taps of an interpolation filter weight spatially neighboring pixels (integer or sub-pel pixels) with coefficient values to generate a sub-pixel value. In general, the interpolation filters used to generate each sub-pixel value at different sub-pixel positions (e.g., ½, ¼, ⅛, or other sub-pixel positions) between two pixels are different (i.e., have different coefficient values).

FIG. 8 is a diagram of full and sub-pixel positions. In the example of FIG. 8, a 6-tap filter is used. This means that values for the sub-pixels or pixel positions 820, 822, 824 can be interpolated by applying an interpolation filter to the pixels 800-810. Only sub-pixel positions between the two pixels 804 and 806 are shown in FIG. 8. However, sub-pixel values between the other full pixels of the line of pixels can be determined in a like manner. For example, a sub-pixel value between the two pixels 806 and 808 may be determined or generated by applying an interpolation filter to the pixels 802, 804, 806, 808, 810, and an integer pixel adjacent to the pixel 810, if available.

Using different coefficient values in an interpolation filter, regardless of its size, results in different characteristics of filtering and hence different compression performance. Each interpolation filter may have a different frequency response.

As described in this example, the first interpolation operation results in an intermediate filter result (e.g., a block of pixels), which pixels are used for the second interpolation operation. The intermediate filter result desirably has a higher precision than the pixel bit depth, which refers to the number of bits per pixel of the image or video frame. In an example, the input bit depth is 8 or 10 bits. For a bit depth of 8 bits, a pixel can have a value of between 0 and 255. For a bit depth of 10 bits, a pixel can have a value of between 0 and 1,023. Other input bit depths are possible. In performing the operations, the pixel values may be normalized so that only integer math is used.

In the filtering operation, such as the example interpolation operation described above, a maximum precision of the intermediate filter result may be specified by the encoder and decoder. For example, the intermediate filter result may have a maximum precision of 16 bits. Stated differently, the pixel values of the intermediate filter result may be limited to 16 bits. To keep the intermediate filter result within this limitation, a fixed value for rounding bits may be used. For example, a first (e.g., horizontal) filter may be applied to an input with a bit depth of 8 bits for interpolation filtering. After this first filtering operation, the signal may be rounded by 3 bits (e.g., right-shifted by 3 bits) so the intermediate filter result is a 16-bit signal. Thereafter, a second (e.g., vertical) filter may be applied to the intermediate filter result. After this second filtering operation, the output may be rounded by 11 bits (e.g., right-shifted by 11 bits) so the output result is an 8-bit signal.

The rounding bits may differ for other input bit depths and other maximum precisions, but they are fixed and may be calculated on the so-called “worst-case” scenario. The worst-case scenario assumes that the values of the input signal are such that a maximum number of bits results after the filtering operations. In some implementations, the values of the input are assumed to be always the lowest value or highest value for the input bit depth. In the 8-bit example above, the worst-case scenario is where the 8-bit input is always 0 (i.e., 00000000) or 255 (i.e., 11111111).

While the described rounding operation provides an intermediate filter result that is within the predefined range (e.g., no more than 16 bits), the right shift rounding lowers the computational precision. Accordingly, the use of the worst-case scenario for determining the rounding bits can be undesirable.

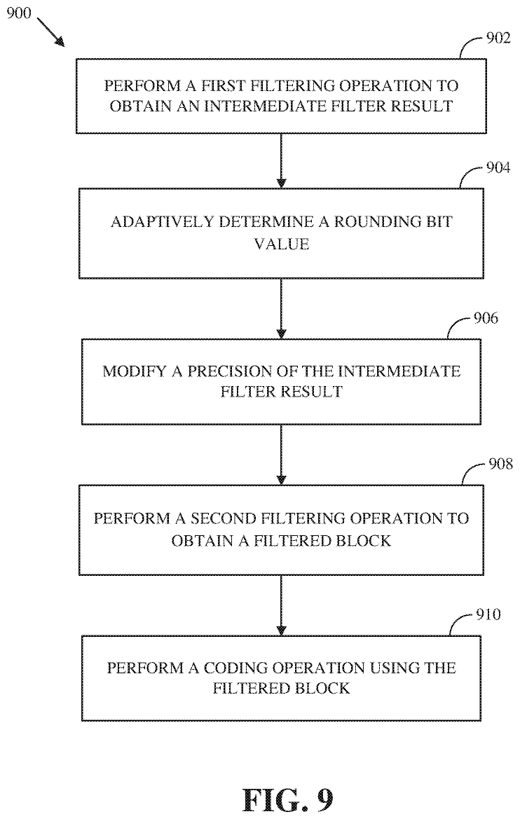

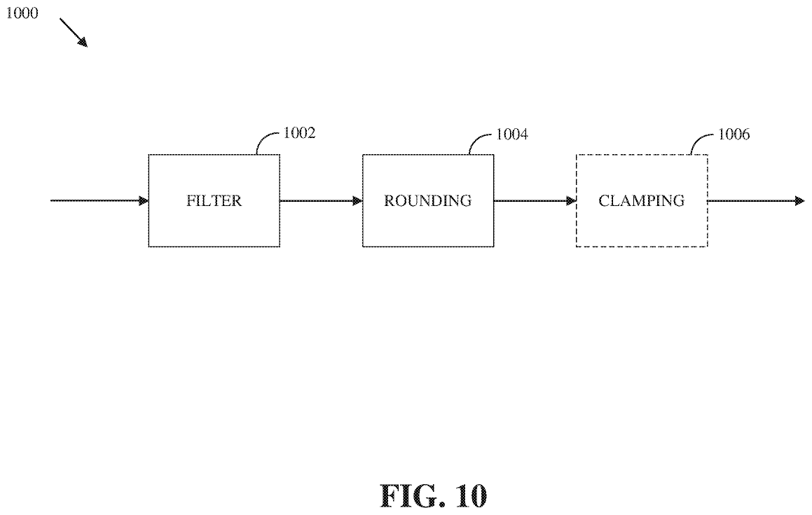

Instead, adaptively determining the filter computation precision using the set of input data (e.g., the unfiltered block) can achieve high computation precision. Further details of this adaptive filter computation precision are described below with regards to FIGS. 9 and 10.

FIG. 9 is a flowchart diagram of a method or process 900 for coding (e.g., encoding and/or decoding) a current block of a video frame using adaptive filter computation precision. The process 900 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the process 900. The process 900 may be implemented in whole or in part in the intra/inter prediction stage 402, the loop filtering stage 416, or both, of the encoder 400 and/or in the intra/inter prediction stage 508, the loop filter stage 512, and/or the post filter stage 514 of the decoder 500. The process 900 can be implemented using specialized hardware or firmware. Multiple processors, memories, or both, may be used.

FIG. 10 is a diagram of a stage of the filter algorithm described with regards to FIG. 9.

At operation 902, the process 900 performs a first filtering operation on a block of pixels to obtain an intermediate filter result. More specifically, the first filtering operation is performed on a block of pixels. The block of pixels may be an unfiltered prediction block generated using a reference frame and a motion vector, such as described above with regards to the example of FIGS. 6-8. The block of pixels may be any unfiltered prediction block generated during prediction at an encoder or decoder, such as at an intra/inter prediction stage 402, 508 at an encoder 400 or decoder 500. In some implementations, the block of pixels may be a unfiltered, reconstructed block of pixels from a reconstructions stage, such as reconstruction stage 414, 510. In yet another implementation, the block of pixels may be an input block into a post filtering stage, such as the post filter stage 514. Any block of pixels that is filtered using two-stage filtering may be used as the block of pixels.

Values of the block of pixels have an input bit depth, and an output of the first filtering operation is an intermediate filter result with a precision that is greater than the input bit depth. For example, referring to FIG. 10, the input may be a block of pixels with an input bit depth or precision (also referred to as a data type size x). The filter 1002 comprises an n-tap filter with coefficients f0, f1, . . . fn−1. The first filtering operation may be performed using the filter 1002 according to equation (1). The output is the intermediate filter result.

At operation 904, a rounding bit value is adaptively determined for modifying the precision of the intermediate filter result. Broadly stated, adaptively determining the rounding bit value may be performed using the values of the block of pixel values input into the filter 1002 to modify the increased precision of the intermediate filter result as compared to the input bit depth.

The rounding bit value may be adaptively determined using the values of the input block directly before the start of filtering. That is, operation 904 may be performed before the operation 902. Alternatively, the rounding bit value (r bits) may be adaptively determined in an in-process analysis after the first filtering operation is performed at operation 902. This latter technique uses the values of the input block after the first filtering operation, that is, the rounding bit value (r bits) may be adaptively determined using the intermediate filter result.

In the in-process analysis, an example is next described. For the intermediate filter result, the minimum value (min) and the maximum value (max) are determined. Thereafter, an offset may be applied to define a result range. The result range, also called the filter result range, may define the number of bits required to represent the range of values of the intermediate filter result. For easier integer math, the offset may be −min such that the result range becomes [0, max −min]. This result range requires a maximum of t bits. For example, a result range of [0, 255] requires 8 bits, so t=8 in this case. The intermediate filter result is limited to y bits (i.e., the output resolution or the data type size of the filter). Accordingly, there are (t−y) bits available for modifying the precision of the intermediate filter result, which is a rounding bit value. Stated more generally, the rounding bit value may be derived based on the output data type size (also referred to as a defined output resolution) and the filter result range. The filter result range is determined by the intermediate filter result, which in turn is determined by the input bits and the filter coefficients.

At operation 906, the precision of the intermediate filter result is modified using the rounding bit value. If t>y, then a right shift operation on the values of the intermediate filter result occurs by (t−y) bits, i.e., the rounding bit value is a positive number. Otherwise, i.e., the rounding bit value is a negative number, a left shift operation on the values of the intermediate filter result occurs by (y−t) bits. That is, the embodiments described herein allow both right shifting and left shifting, respectively decreasing and increasing a resolution of the intermediate filter result. The rounding bit value can be positive or negative. A positive rounding bit value results in a right shift operation (i.e., a decrease in bit depth), and a negative rounding bit value results in a left shift operation (i.e., an increase in bit depth).

A downside of this in-process analysis is that an extra buffer is required to store the intermediate filter result so that the offset is known and can be used to adjust the resulting pixel values after the first filtering operation. An alternative process to adaptively determine the rounding bit value in an estimate (also called a fast estimate herein) that uses the values of the input block of pixels and the filter coefficients.

In the fast estimate, the minimum (pₘᵢₙ) and maximum (pₘₐₓ) values of the input block of pixels are determined. The sum of the positive filter coefficients (sum_f_pos) and the sum of the negative filter coefficients (sum_f_neg) may also be determined. The maximum filter result (max) may be estimated as equation (2) below:

$$max = sum\_f \_pos * {p}_{max} + sum\_f \_neg * {p}_{min}$$

Similarly, the minimum filter result (min) may be estimated as equation (3) below:

$$min = sum\_f \_pos * {p}_{min} + sum\_f \_neg * {p}_{max}$$

Thereafter, the fast estimate proceeds as described with regards to the in-process analysis described above. That is, an offset may be applied to define a result range. For easier integer math, the offset may be −min such that the result range becomes [0, max−min]. This result range requires t bits. The intermediate filter result requires y bits (i.e., the output resolution or the data type size). Accordingly, there are (t−y) bits available for modifying the precision of the intermediate filter result. Operation 906 occurs in the same way is described above.

As can be seen from reference to FIG. 10, an optional clamping step may be performed at a clamping stage 1006. The clamping stage 1006 can be used to adjust the output bit depth (e.g., from y bits) to a resolution or precision other than the rounding precision resulting from the modification at operation 906 and/or to a resolution or precision other than the input bit depth. The output bit depth may be greater than or less than the input bit depth, for example. The clamping stage 1006 is optional, in part, because the techniques herein may be used to adjust the output resolution of a filtering operation to a wide range of bit depths.

Referring again to FIG. 9, after the precision of the intermediate filter result is modified at operation 906 (whether the optional clamping step is performed or not), the process 900 advances to perform a second filtering operation to obtain a filtered block at operation 908. More specifically, the second filtering operation is performed on the intermediate filter result after modifying the precision, and an output of the second filtering operation comprises a filtered block of pixels.

FIG. 10 represents a single stage of a filter algorithm described herein. That is, adaptive filter computation precision may be used in a single stage of a multi-stage filtering process, more than one stage of a multi-stage filtering process, or all stages of a multi-stage filtering process. In some implementations, other stages may use respective fixed rounding bits determined based on the desired output resolution and the input resolution to the filter stage. Accordingly, the second filtering operation performed at operation 908 may be performed similarly to the first filtering operation, namely, adaptively determining a rounding bit value as described with regards to operation 904, e.g., using either the in-process analysis or the fast estimate, and optionally clamping the output resolution to a desired value. In this two-stage filtering example, clamping is omitted from the first stage (i.e., is not done after the first filtering operation) and is optional in the second stage (i.e., is optional after the second filtering operation).

Thereafter, a coding operation is performed using the filtered block of pixels at operation 910. The type of the coding operation depends upon what stage of the encoder and/or decoder is performing the filtering. For example, the coding operation may be encoding a current block of an image or video frame where the filtered block of pixels is a prediction block determined for prediction, such as at the intra/inter prediction stage 402 of the encoder 400. For example, the coding operation may be decoding a current block of an image or video frame where the filtered block of pixels is a prediction block determined for prediction, such as at the intra/inter prediction stage 508 of the decoder 500. The filtered block of pixels may be combined with another prediction block, whether filtered according to the techniques described herein or not, for use in a compound prediction mode.

Where the filtered block of pixels is the output of in-loop filtering, such as at the loop filtering stage 416 of the encoder 400 and/or the loop filter stage 512 of the decoder 500, the coding operation can include storing the filtered block of pixels for use in the prediction of one or more subsequent blocks in the same image or video frame or in a subsequent video frame.

Where the filtered block of pixels is the output of post filtering, such as at the post filter stage 514 of the decoder 500, the coding operation can include displaying and/or storing the filtered block of pixels within an image or video frame.

The techniques described herein represent improvements over using a fixed rounding bit value for filtering based on the worst-case scenario. The rounding bits can be derived adaptively for each input block of pixels, which enables higher precision to be kept (e.g., when bits are available). Higher precision filtering can produce more accurate filtered pixels (e.g., better predictions and/or better reconstructed blocks) and can result in higher coding efficiency.

For simplicity of explanation, the processes according to the teachings herein are depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized that contains other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

What is claimed is:

1. A method, comprising:
performing a first filtering operation on a block of pixels, wherein values of the pixels have an input bit depth, and an output of the first filtering operation is an intermediate filter result with a precision that is greater than the input bit depth;
adaptively determining a rounding bit value for modifying the precision of the intermediate filter result;
modifying the precision of the intermediate filter result using the rounding bit value;
performing a second filtering operation on the intermediate filter result after modifying the precision, wherein an output of the second filtering operation comprises a filtered block of pixels; and
performing a coding operation using the filtered block of pixels.

2. The method of claim 1, wherein the filtered block of pixels is a prediction block and performing the coding operation comprises:
decoding a current block of a frame using the prediction block.

3. The method of claim 1, wherein adaptively determining the rounding bit value comprises:
determining a maximum number of bits required to represent a range of values of the intermediate filter result; and
determining the rounding bit value as a difference between the maximum number of bits and a defined output resolution of the first filtering operation.

4. The method of claim 3, wherein determining the maximum number of bits comprises:
determining a maximum value of the input block of pixels;
determining a minimum value of the input block of pixels;
estimating a maximum value of the intermediate filter result using the maximum value of the input block of pixels, the minimum value of the input block of pixels, and filter coefficients of the first filtering operation;
estimating a minimum value of the intermediate filter result using the maximum value of the input block of pixels, the minimum value of the input block of pixels, and filter coefficients of the first filtering operation; and
determining the maximum number of bits as a difference between the maximum value of the intermediate filter result and the minimum value of the intermediate filter result.

5. The method of claim 3, wherein determining the maximum number of bits comprises:
determining a maximum value of the intermediate filter result;
determining a minimum value of the intermediate filter result; and
determining the maximum number of bits as a difference between the maximum value and the minimum value.

6. The method of claim 1, comprising, before performing the coding operation:
adaptively determining a second rounding bit value for modifying a precision of the filtered block of pixels; and
modifying the precision of the filtered block of pixels using the second rounding bit value.

7. The method of claim 1, wherein:
the rounding bit value is a negative number; and
modifying the precision of the intermediate filter result comprises left shifting values of the intermediate filter result by a number of bits indicated by the negative number.

8. An apparatus, comprising:
a processor configured to:
perform a first filtering operation on a block of pixels, wherein values of the pixels have an input bit depth, and an output of the first filtering operation is an intermediate filter result with a precision that is greater than the input bit depth;
adaptively determine a rounding bit value for modifying the precision of the intermediate filter result;
modify the precision of the intermediate filter result using the rounding bit value;
perform a second filtering operation on the intermediate filter result after modifying the precision, wherein an output of the second filtering operation comprises a filtered block of pixels; and
perform a coding operation using the filtered block of pixels.

9. The apparatus of claim 8, wherein:
to perform the first filtering operation comprises to apply a horizontal filter to the input block of pixels; and
to perform the second filtering operation comprises to apply a vertical filter to the intermediate filter result after modifying the precision.

10. The apparatus of claim 8, wherein:
to perform the first filtering operation comprises to apply a vertical filter to the input block of pixels; and
to perform the second filtering operation comprises to apply a horizontal filter to the intermediate filter result after modifying the precision.

11. The apparatus of claim 8, wherein the processor is configured to:
adaptively determine a second rounding bit value for modifying a precision of the filtered block of pixels;
modify the precision of the filtered block of pixels using the second rounding bit value; and
perform the coding operation after modifying the precision of the filtered block of pixels.

12. The apparatus of claim 11, wherein the processor is configured to:
clamp a precision of the filtered block of pixels to a value different from a modified precision of the filtered block of pixels.

13. The apparatus of claim 11, wherein a modified precision of the filter block of pixels is greater than the input depth.

14. The apparatus of claim 11, wherein:
to adaptively determine the rounding bit value comprises to determine the rounding bit value using values of the input block of pixels, filter coefficients of the first filtering operation, and a defined output resolution of the first filtering operation; and
to adaptively determine the second rounding bit value comprises to determine the second rounding bit value using values of the intermediate filter result after modifying the precision of the intermediate filter result, filter coefficients of the second filtering operation, and a defined output resolution of the second filtering operation.

15. The apparatus of claim 8, wherein:
to adaptively determine the rounding bit value comprises to determine the rounding bit value using values of the input block of pixels, filter coefficients of the first filtering operation, and a defined output resolution of the first filtering operation.

16. The apparatus of claim 15, wherein to determine the rounding bit value using the values of the input block of pixels, the filter coefficients of the first filtering operation, and the defined output resolution of the first filtering operation comprises to:
determine a minimum (pₘᵢₙ) value and a maximum (pₘₐₓ) value of the input block of pixels;
determine a sum of positive filter coefficients (sum_f_pos) and a sum of negative filter coefficients (sum_f_neg) of the filter coefficients;
estimate a maximum value of the intermediate filter result (max) according to:
max=sum_f_pos*pₘₐₓ+sum_f_neg*pₘᵢₙ;
estimate a minimum value of the intermediate filter result (min) according to:
min=sum_f_pos*pₘᵢₙ+sum_f_neg*pₘₐₓ;
determine a result range [0, max−min] of the intermediate filter result that is represented by t bits; and
determine the rounding bit value as (t−y), wherein y bits is the defined output resolution of the first filtering operation.

17. The apparatus of claim 16, wherein to modify the precision of the intermediate filter result comprises:
to right shift values of the intermediate filter result by (t−y) bits when t>y; and
otherwise, to left shift values of the intermediate filter result by (y−t) bits.

18. The apparatus of claim 15, wherein to determine the rounding bit value using the values of the input block of pixels, the filter coefficients of the first filtering operation, and the defined output resolution of the first filtering operation comprises to:
determine a maximum value of the intermediate filter result (max);
determine a minimum value of the intermediate filter result (min);
determine a result range [0, max−min] of the intermediate filter result that is represented by t bits; and
determine the rounding bit value as (t−y), wherein y bits is the defined output resolution of the first filtering operation.

19. A computer-readable storage medium storing instructions for performing a method, the method comprising:
performing a first filtering operation on a block of pixels, wherein values of the pixels have an input bit depth, and an output of the first filtering operation is an intermediate filter result with a precision that is greater than the input bit depth;
adaptively determining a rounding bit value for modifying the precision of the intermediate filter result;
modifying the precision of the intermediate filter result using the rounding bit value;
performing a second filtering operation on the intermediate filter result after modifying the precision, wherein an output of the second filtering operation comprises a filtered block of pixels; and
performing a coding operation using the filtered block of pixels.

20. The computer-readable storage medium of claim 19, wherein the method comprises:
clamping the filtered block of pixels to an output bit depth different from the input bit depth before performing the coding operation.
